(19) United States
(12) Patent Application Publication
(10) Pub. No.: US 2008/0308131 A1
(43) Pub. Date: Dec. 18, 2008

(54) Method and apparatus for cleaning and driving wafers

(75) Inventors: One-Vai Kim, Chonan-shi (KR); Jae-Sun Han, Chonan-shi (KR); Jeong-Yong Bae, Chonan-shi (KR); Jung-Keun Cho, Seoul (KR)

Correspondence Address: HARNESS, DICKEY & PIERCE, P.L.C., P.O. BOX 8910, RESTON, VA, 20195, US

(73) Assignee: Semes Co., Ltd.

(21) Appl. No.: 12/222,697

(22) Filed: Aug. 14, 2008

Related U.S. Application Data
(62) Division of application No. 11/073,687, filed on Mar. 8, 2005.

(51) Int. Cl. B08B 3/02; B08B 3/04; B08B 5/02

(52) U.S. Cl. 134/30; 134/33

(57) ABSTRACT

The present invention is directed to a method and an apparatus for cleaning and drying wafers. The apparatus includes an injection unit having first and second injection ports configured for injecting different fluids and arranged in a moving direction of the rose or on a line adjacent to the moving direction. The injection unit migrates straightly from the center of a wafer to the edge thereof, and the first and second injection ports are linearly arranged on a moving line of the nozzle.

### FIELD OF THE INVENTION

The present invention is directed to apparatus and method for cleaning and drying wafers while rotating the wafers.

### BACKGROUND OF THE INVENTION

In manufacturing semiconductor devices, depositing insulating and metal layers, etching, coating photoresist, developing, and removing asher are iteratively performed to fine patterns. Foreign materials created in the respective processes are removed by a wet cleaning process using deionized water (DI water) or chemicals, which is called a wet cleaning process.

Such coating photoresist, developing, and cleaning processes is performed by injecting liquid chemicals or DI water onto a wafer. A typical drying and cleaning apparatus chucks a-wafer using a wafer chuck that is able to treat only a wafer. While the wafer is rotated using a motor, chemicals or DI water flows from the top of the wafer through an injection nozzle. Thus, the chemicals or the DI water flows throughout an entire surface of the wafer due to a rotatory power of the wafer to perform a process.

A single-type wafer cleaning and drying apparatus rinses a wafer using DI water and then dries the wafer using N₂ gas.

However, with the recent trend toward larger wafers and finer patterns formed on a wafer, DI water used in a rinsing process tends to be incompletely dried or undried.

### SUMMARY OF THE INVENTION

A feature of the present invention is to provide a met-hod and apparatus for cleaning and drying wafers to enhance a dry efficiency using a Marangoni style drying-methodology.

Another feature of the present invention is to provide a method and an apparatus for cleaning and drying wafers to shorten cleaning (rinsing) and drying time.

In order to achieve these features, there is provided a wafer processing apparatus. The apparatus includes a spin head for keeping a to-be-processed surface of a wafer facing upwardly and rotating the wafer, an injection unit having a nozzle configured for injecting fluids to a to-be-processed surface of a wafer placed on the spin head to clean and dry the wafer, and a moving unit for moving the nozzle of the injection unit to the edge of a wafer to the center thereof. The nozzle has first and second injection ports configured for injecting different fluids and arranged in a moving direction of the rose or on a line adjacent to the moving direction.

In some embodiments, the nozzle is straightly moved to the edge of a wafer to the center thereof by the moving unit. The first and seconds injection ports are linearly arranged on-a straight moving line of the nozzle.

In some embodiments, the nozzle migrates rotationally from the center of the wafer to the edge thereof. The first and second injection ports are linearly arranged on a rotational migration line of the nozzle.

In some embodiments, the apparatus further includes a-fluid supply unit for supplying fluids to the first and second injection ports. The fluid supply unit supplies fluids when the first or second injection port is disposed at the center of the wafer.

In some embodiments, the injection unit migrates to the edge of a wafer while the first and second injection ports pass sequentially the center of the wafer. The first injection port injects a first fluid for cleaning a wafer, and a second fluid injects-a second injection fluid for drying the wafer.

In some embodiments, the first fluid may be deionized water (DIW) or DIW mixed solution containing isopropyl alcohol (IPA), and the second fluid may be N₂ or mixed gas containing N₂.

In some embodiments, the nozzle further has at least one third injection port installed between the first and second injection ports. The injection unit migrates to the edge of a wafer while the first, third, and second injection ports pass the center sequentially.

In some embodiments, the first injection port injects a-first fluid for cleaning a wafer, the third injection port injects a second fluid for primary dry of the wafer, and the second injection port injects a third fluid for secondary dry of the wafer.

In order to achieve these features, there is provided a method for cleaning and drying wafer in an apparatus with an injection unit having injection ports that are linearly-arranged in a moving-direction of a nozzle to inject different fluids. The method includes rotating a wafer while keeping the wafer and injecting fluids onto a surface of the wafer while the injection unit migrates from the center of the wafer to the edge thereof. The injection of the fluids includes injecting a first fluid for cleaning to the surface of the wafer while a first injection port migrates from the center of the wafer to the edge thereof and injecting a second fluid for drying the cleaned surface of the wafer while a second injection port migrates following the first injection port.

In some embodiments, the method further includes injecting a third fluid for secondary dry of the primarily dried surface of the wafer while a third injection port migrates following the second injection port.

### BRIEF DESCRIPTION OF THE DRAWINGS

FIG. 1 is a side view of a wafer processing apparatus according to the present invention.

FIG. 2 is a top plan view of the wafer processing apparatus according to the present invention.

FIG. 3A through FIG. 3D are diagrams for explaining straight movement manners of an injection unit according to the present invention.

FIG. 4 through FIG. 7 are diagrams for explaining a wafer cleaning and drying method according to the present invention.

FIG. 8 through FIG. 10 are diagrams for explaining modified versions of injection ports of an injection unit.

FIG. 11 is a diagram where a wafer is cleaned and dried by supplying IPA vapor to the upside of a wafer, in the state of FIG. 8.

### DETAILED DESCRIPTION OF THE INVENTION

The present invention will now be described more fully hereinafter with reference to the accompanying drawings, in which preferred embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

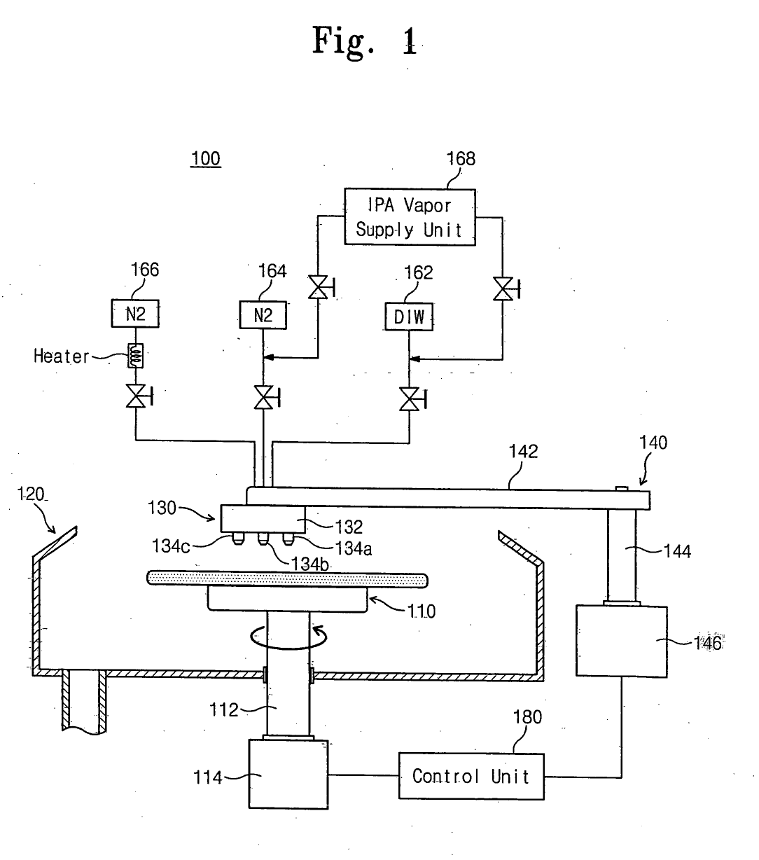

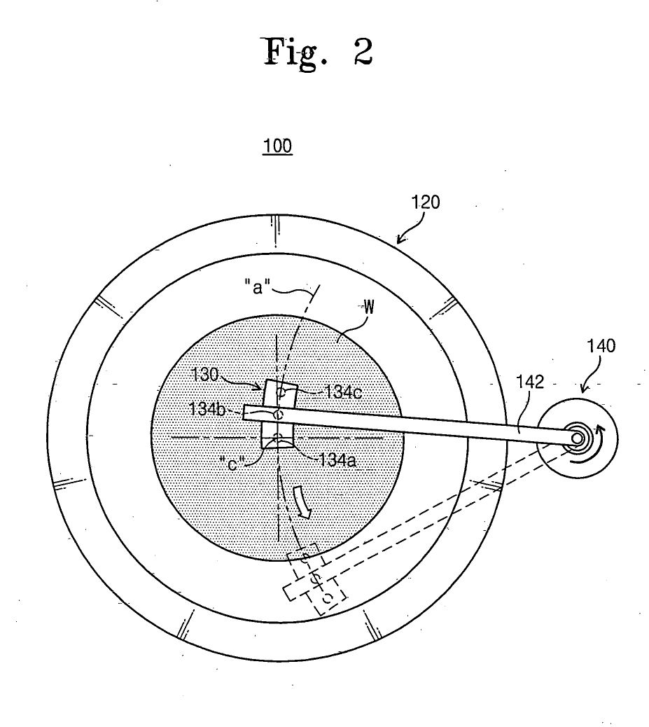

As illustrated in FIG. 1, a wafer cleaning and drying apparatus 100 has a spin head 110 on which a wafer is maintained. A rotation axis 112 is connected to the bottom of the spin head 110 to support the spin head 110 and transfer a rotatory power. A spin motor 114 is connected to the rotation axis 112 to supply the rotatory power.

A catch cup 120 is installed around the spin head 110. The catch cup 120 prevents liquids supplied to a wafer “W” from being scattered while cleaning and drying the wafer “W”. Thus, external apparatuses or vicinity is not contaminated.

Although not shown in this figure, the catch cup 120 and the spin head 110 are constructed to relatively move up and down. While they relatively move up and down, a wafer is put in the catch cup 120 or a processed wafer is pull out from the catch cup 120.

An injection unit 130 is installed over the spin head 110 to inject cleaning (or rinsing) solution and dry gas onto a wafer surface. A nozzle 132 of the injection unit 130 injects cleaning (or rinsing) solution and dry gas to a to-be-processed surface of the wafer “W” while moving to the center “c” of a wafer to the edge thereof. The injection unit 130 is connected to an arm 142 of a moving unit 140 to move the injection unit 130.

The moving unit 140 includes a driving motor 146, a support axis 144 for receiving a rotatory power from the driving motor 146, and the arm 142 installed at the support axis 144. The injection unit 130 is installed at the end of the arm 142. The driving motor 146 operates on a control signal of a control unit 180 for controlling a progression of a wafer cleaning and drying process.

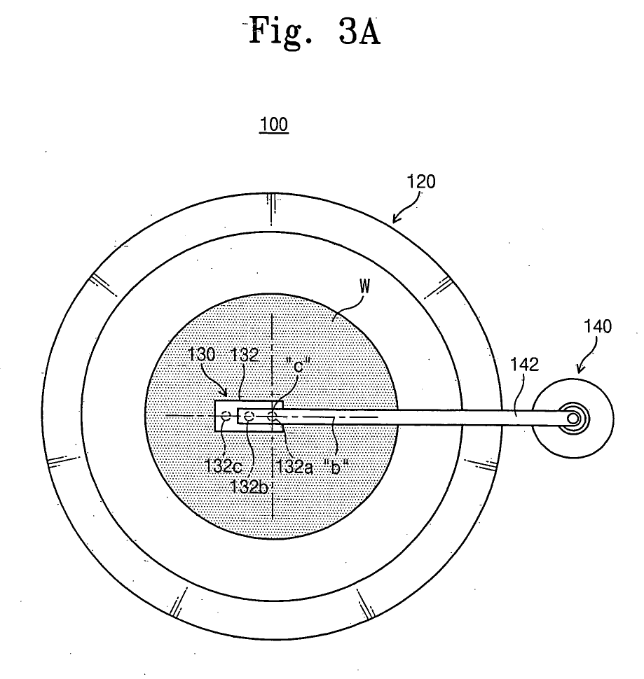

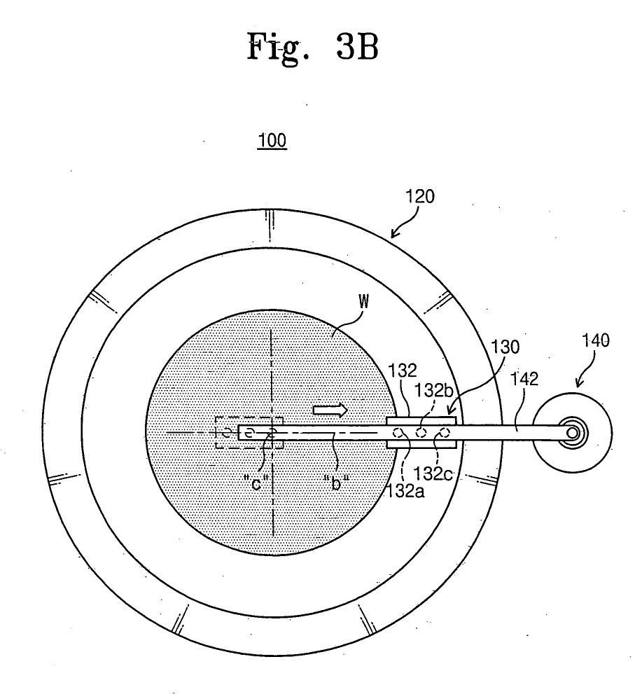

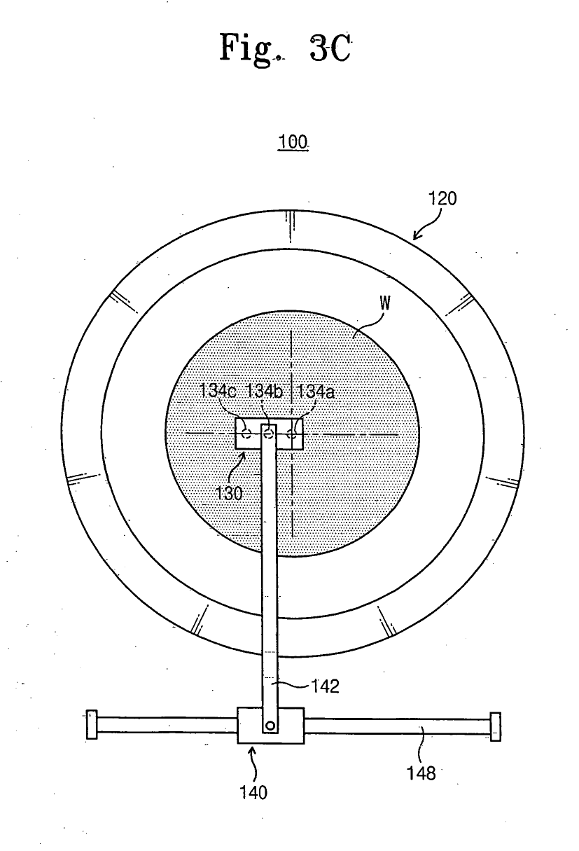

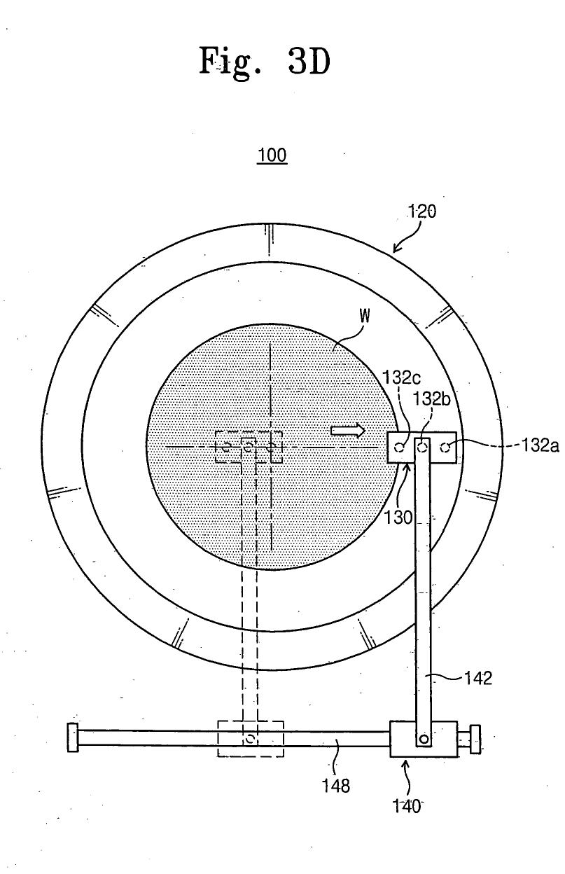

A nozzle 132 of the injection unit 130 includes a first injection port 134a, a second injection port 134b, and a third injection port 134c which are configured for injecting different liquids. These injection ports are linearly arranged in a moving direction of the injection unit 130 or on a line adjacent to the moving direction thereof. In this embodiment, the injection port 130 migrates rotationally on the support axis 144. The injection ports 134a, 134b, and 134c are linearly arranged on a line “a” having the same radius of gyration passing the center “c” of a wafer. If the injection unit 130 migrates straightly, not rotationally, injection ports are linearly arranged on a line “b” passing the center of a wafer, as illustrated in FIG. 3. There may be a variety of straight migration manners of the injection unit 130. As illustrated in FIG. 3A and FIG. 3B, the injection port 130 migrates straightly over an arm 142 of a moving unit. As illustrated in FIG. 3C and FIG. 3D, a whole moving unit 140 migrates straightly along a transfer rail 148.

A-DIW supply part 162 for cleaning (rinsing) wafers is connected to the first injection port 134a, and an N₂ supply part 164 for drying wafers is connected to the second injection port 134b. A high-temperature N2 gas supply part 166 for secondary dry of wafers is connected to a-third injection port 134c. In order to obtain Marangoni effect while drying wafers, a DIW mixed solution containing IPA vapor and an N₂ mixed gas containing IPA vapor may be supplied to the first and second injection ports, respectively.

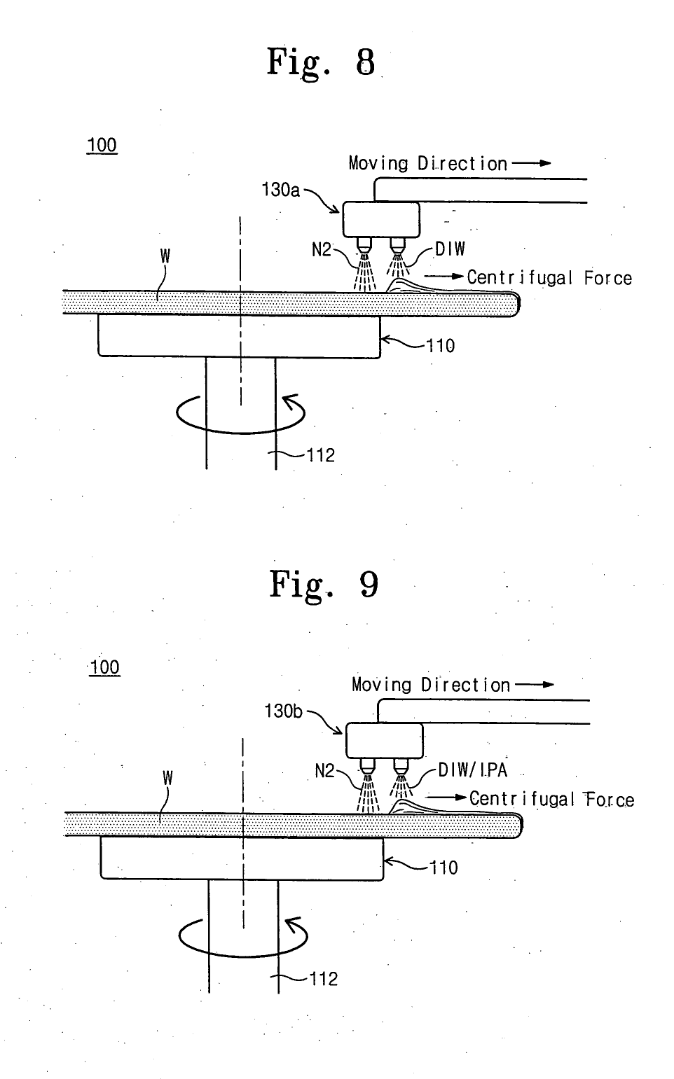

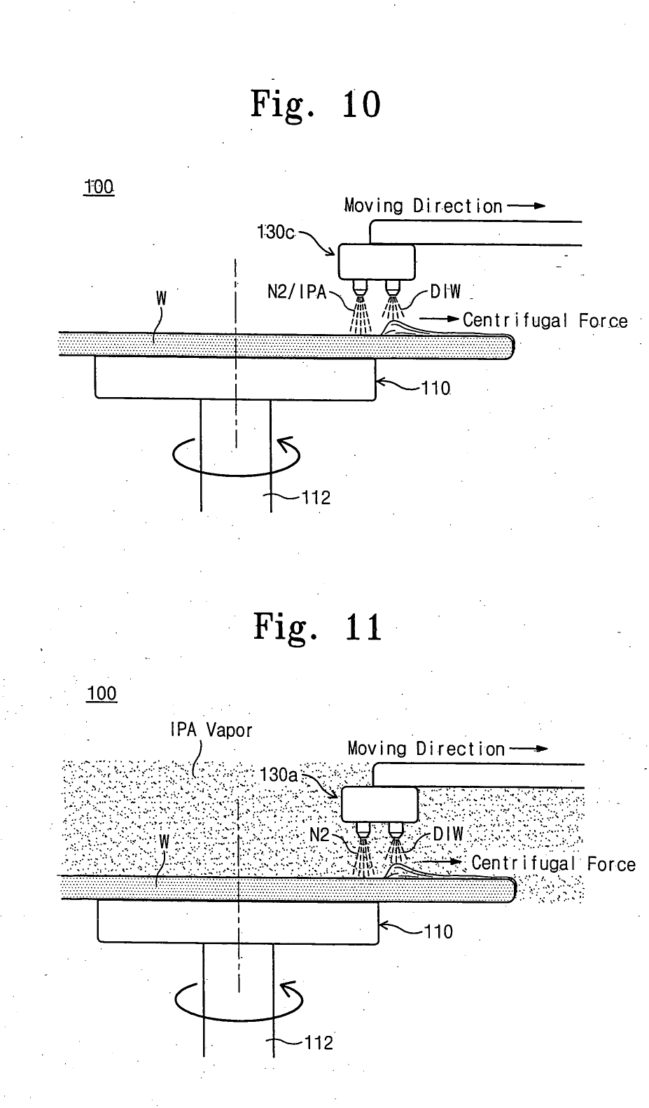

FIG. 8 and FIG. 10 illustrate modified versions of injection ports of the injection unit. In FIG. 8, there is illustrated an injection unit 130a including a DIW injection port and an N₂ injection port. In FIG. 9, there is illustrated an injection unit 130b including an injection port for DIW mixed solution containing IPA vapor and an N₂ injection port. In FIG. 10, there is illustrated an injection unit 130c including a DIW injection port and an injection port for N₂ mixed gas containing IPA vapor.

In FIG. 11, there is illustrated the example that a wafer is cleaned and dried under a IPA vapor ambient established by supplying IPA vapor to the whole upside of the wafer.

As described above, the number of injection ports or kinds of liquids supplied to injection ports may vary with methods for cleaning and drying wafers. Also, a space between the injection ports may vary therewith.

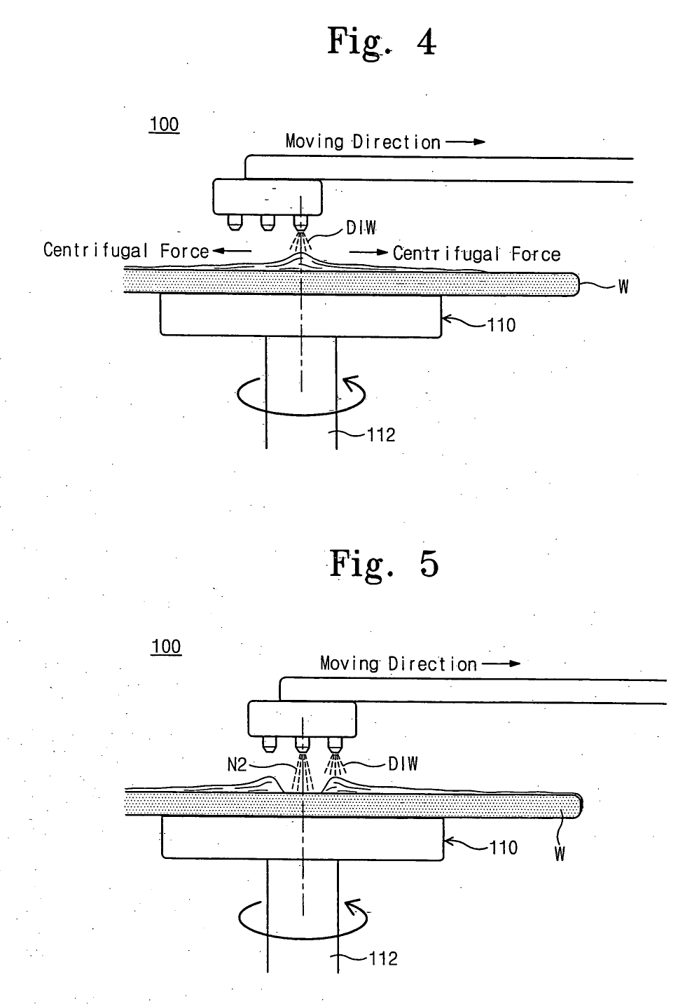

FIG. 4 through FIG. 7 show the steps of cleaning and drying a wafer using the injection unit.

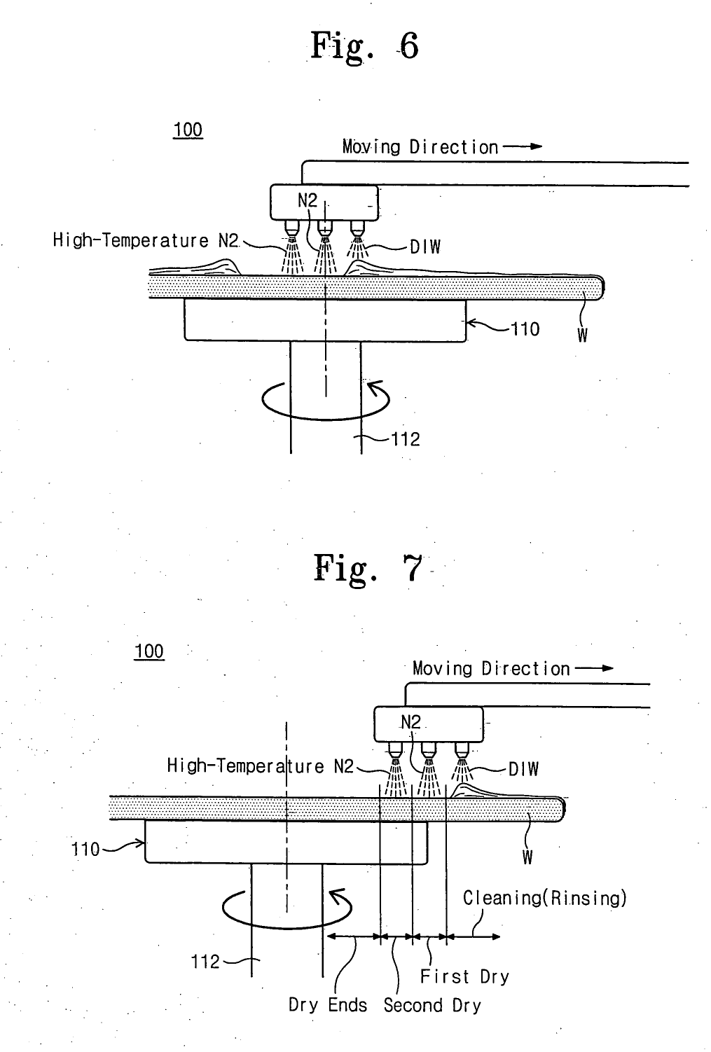

If a wafer “W” is placed on a spin head 110, it is fixed by means of vacuum and then rotates. A first injection port 134a of an injection-unit 130 is located at the center of a wafer by a moving unit 140. Deionized water (DIW) for cleaning wafers is injected from the first injection port 134-a. If a wafer starts to be cleaned at the first injection port 134a, the moving part 140 slowly transfers the injection port 130 from the center of the wafer to the edge thereof. If a second injection port 134b is located at the center of the wafer, N₂ gas for drying the wafer is injected from the second injection port 434b (see FIG. 5). If a third injection port 134c is located at the center of the wafer, high-temperature N₂ gas for secondary dry of the wafer is injected form the third injection port 134c (see FIG. 6).

The injection unit 130 of the substrate cleaning and drying apparatus 100 cleans and dries a wafer at the same time while moving the center of the wafer to the edge thereof. Note that injection ports of the injection unit 130 are arranged sequentially (based on processes, i.e., cleaning-primary dry-secondary dry) on their path passing the center of a wafer and fluids are injected onto the injection ports while they sequentially pass the center of the wafer.

In the present invention, the above-mentioned wafers include substrates for a reticle, display panel substrates such as substrates for liquid display panel and substrates for plasma display panel, substrates for hard disk, and wafers for electronic devices such as semiconductor devices.

As explained so far, wafers are cleaned and dried at the same time to shorten an entire process time. Advantageously, dry defects of a wafer are reduced. Particularly, the entire surface of the wafer is fully dried without generation of watermarks.

Other modifications and variations to the invention will be apparent to a-person skilled in the art from the foregoing disclosure. Thus, while only certain embodiment of the invention has been specifically described herein, it will be apparent that numerous modifications may be made thereto without departing from the spirit and scope of the invention.

1.-8. (canceled)

9. A method for cleaning and drying wafer in an apparatus with an injection unit having injection ports that are linearly arranged in a moving direction of a nozzle to inject different fluids, the method comprising:
rotating a wafer while keeping the wafer; and
injecting fluids onto a surface of the wafer while the injection unit migrates from the center of the wafer to the edge thereof;
wherein the injection of the fluids comprises:
injecting a first fluid for cleaning to the surface of the wafer while a first injection port migrates from the center of the wafer to the edge thereof; and
injecting a second fluid for drying the cleaned surface of the wafer while a second injection port migrates following the first injection port to simultaneously process a cleaning and a drying of the wafer.

10. The method of claim 9, wherein the first fluid is deionized water (DIW) or DIW mixed solution containing isopropyl alcohol (IPA), and the second fluid is N₂ or mixed gas containing N₂.

11. The method of claim 9, further comprising:
injecting a third fluid for secondary dry of the primarily dried surface of the wafer while a third injection port migrates following the second injection port.

12. The method of claim 11, wherein the first fluid is deionized water (DIW) or DIW mixed solution containing isopropyl alcohol (IPA);
the second fluid is N₂ or N₂ mixed gas containing IPA; and
the third fluid is a high-temperature N₂.

13. The method of claim 9, wherein the injecting of the fluids further comprises:
injecting the first fluid before, forming a IPA vapor ambient supplying IPA vapor to the whole upside of the wafer.
